(19) United States
(12) Patent Application Publication
(10) Pub. No.: US 2006/0197716 A1
(43) Pub. Date: Sep. 7, 2006

(54) Liquid crystal display device

(76) Inventors: Yoshinori Tanaka, Ooamishirasato (JP); Tomohide Oohira, Mobara (JP); Hiroshi Yoshioka, Mobara (JP); Yoshiteru Tomizuka, Mobara (JP); Satoshi Takahashi, Isumi (JP)

Correspondence Address: REED SMITH LLP, Suite 1400, 3110 Fairview Park Drive, Falls Church, VA, 22042, US

(21) Appl. No.: 11/362,171

(22) Filed: Feb. 27, 2006

(30) Foreign Application Priority Data
Mar. 2, 2005 (JP) 2005-056948
Sep. 5, 2005 (JP) 2005-255971

(51) Int. Cl. G09G 5/00

(52) U.S. Cl. 345/6

(57) ABSTRACT

The present invention provides a display device which can provide a stereoscopic display to a viewer by overlapping a plurality of sheets of liquid crystal panels. A front liquid crystal panel and a rear liquid crystal panel are overlapped to each other. The display device also includes a TCON board on which timing controllers which are connected with a front liquid crystal panel and a rear liquid crystal panel are arranged. The timing controllers output output I/F signals to the front liquid crystal panel and the rear liquid crystal panel based on input I/F signals which are inputted from an external image signal source.

### CROSS-REFERENCE TO RELATED APPLICATIONS

The disclosure of Japanese Patent Application No.2005/56948 filed on Feb. 3, 2005 including the specification, drawings and abstract and the disclosure of Japanese Patent Application No.2005/255971 filed on May 9, 2005 including the specification, drawings and abstract are incorporated herein by reference in its entirety.

### BACKGROUND OF THE INVENTION

1. Field of the Invention

The present invention relates to a display device, and more particularly to a display device which displays an image which appears stereoscopically by overlapping images which are displayed on a plurality of display devices.

2. Description of Related Art

With respect to a technique which allows a display screen to display a three-dimensional stereoscopic image thereon without using particular glasses or the like, Japanese Patent Laid-open No. 2001/54144(document 1) can be named. In the document 1, on a plurality of display screens which are arranged at depth positions different from each other as viewed from a viewer, two-dimensional images which are generated by projecting an object to be displayed from the viewing direction of the viewer are respectively displayed, and the luminances of the two-dimensional images to be displayed are respectively independently changed for every display screen thus generating the three-dimensional stereoscopic image. Further, in the document 1, with respect to this three-dimensional display method, there exists a description that the transmissivities of two-dimensional images which are displayed on the respective display screens are independently changed for every display screen thus independently changing the luminances of the two-dimensional images which are displayed on respective image screens.

### SUMMARY OF THE INVENTION

However, in the document 1, there exists no description with respect to the specific manner of data handling for the plurality of display screens, and the specific constitutions of a timing controller, a memory and a driver which enable the stereoscopic display.

It is an object of a present invention to provide a display device which can allow a viewer to observe a stereoscopic display by overlapping image display parts of a plurality of display devices.

In using the display devices by physically overlapping the display devices between a front face and a rear face, it is necessary to form these display devices using a transmissive display device except for a lowermost display device of a plurality of overlapped display devices. It is needless to say that the lowermost display device may be also formed of a transmissive display device. Here, as a matter of course, when the lowermost display device is formed of the transmissive display device, a backlight device which arranges a light source such as CFL or LED thereon is arranged on a back surface of a lowermost display device. Here, as the display device used in the present invention, the explanation is mainly made with respect to a case in which two sheets of liquid crystal panels which constitute a typical example of the transmissive display device are used. It is needless to say that the display device of the present invention can be constituted by using a cathode ray-tube display device, a plasma display device, an organic EL display device, or a display device which uses thin film electron sources on the rear surface, and a transmissive display device which is represented by a liquid crystal panel is overlapped to an upper side (front surface, viewer side) of the display device. In the present invention, the explanation is made by adopting the display device which displays an image appearing stereoscopically by stacking two sheets of transmissive liquid crystal panels and by overlapping images which are produced by the respective liquid crystal panels as a typical example of the stereoscopic display device.

The display device of the present invention generates a three-dimensional image by overlapping a two-dimensional image which is displayed on a display part of a first display device arranged on a front face and a two-dimensional image which is displayed on a display part of a second display device arranged on a rear face. Further, the display device includes a first display signal generating device which outputs a display timing signal and display data for the first display device to the first display device as a first output I/F signal based on a first input I/F signal for the front face display device which is inputted from an external image signal source, and a second display signal generating device which outputs a display timing signal and display data for the second display device to the second display device as a second output I/F signal based on a second input I/F signal for the rear face display device which is inputted from an external image signal source in the same manner.

According to one aspect of the present invention, the first display device is constituted of a front face liquid crystal panel and the second display device is constituted of a rear face liquid crystal panel which is overlapped to a rear face of the front face liquid crystal panel. The first display signal generating device is constituted of a first timing controller (first TCON) for the front face liquid crystal panel, and the second display signal generating device is constituted of a second timing controller (second TCON) for the rear face liquid crystal panel.

Further, according to another aspect of the present invention, the display device which is constituted by overlapping a front face liquid crystal panel and a rear face liquid crystal panel includes a timing controller board (TCON board) on which a first timing controller for the front face liquid crystal panel and a second timing controller for the rear face liquid crystal panel are arranged. Further, the first timing controller outputs an output I/F signal to the front face liquid crystal panel based on an input I/F signal inputted from an external image signal source. On the other hand, the second timing controller outputs an output I/F signal to the rear face liquid crystal panel based on an input I/F signal inputted from an external image signal source.

Due to such constitutions, it is possible to provide a display device which provides a stereoscopic display to a viewer by supplying the signals to the front face liquid crystal panel and the rear face liquid crystal panel.

According to still another aspect of the present invention, a display device which is constituted by overlapping the front face liquid crystal panel and the rear face liquid crystal panel includes a timing controller board (TCON board) on which a timing controller (TCON) which is connected to the front face liquid crystal panel and the rear face liquid crystal panel is arranged. The timing controller outputs an output I/F signal to the front face liquid crystal panel and the rear face liquid crystal panel based on the input I/F signal inputted from an external image signal source.

Due to such a constitution, it is possible to provide the display device which can provide a stereoscopic display to a viewer by supplying the display signals to the front face liquid crystal panel and the rear face liquid crystal panel.

Further, the input I/F signal is used as the signal which is used in common by the front face liquid crystal panel and the rear face liquid crystal panel, while the output I/F signal is separately outputted as the output signal for the front face liquid crystal panel and the output signal for the rear face liquid crystal panel.

The input I/F signal includes RGB signals which indicate color information on the display signals and a Z signal which indicates hierarchical information (also referred to as space information, positional information, depth information, or depth information, hereinafter, also referred to as hierarchical information or hierarchical data) of a position between the front face liquid crystal panel and the rear face liquid crystal panel.

In such a display device, the sum of number of terminals on the input side of the timing controller (TCON) which is constituted of an LSI chip can be set smaller than the sum of number of terminals on the output side of the timing controller (TCON). To be more specific, the sum of the number of terminals relevant to the color information and the hierarchical information on the input side of the timing controller can be set smaller than the sum of the number of terminals relevant to the color information on the output side. For example, when the input I/F signal is configured such that the color information on R, G, B which constitute the image display data is formed of 6-bits information for each color and the hierarchical information is formed of 6-bits information, the number of terminals on the input side becomes 24 and the number of terminals on the output side becomes 36. Accordingly, the present invention can provide the display device capable of performing a three-dimensional display at a low cost eventually.

In the display device, the timing controller (TCON) includes an integral memory. The integral memory stores a luminance distribution table which is information for generating the output I/F signals for the front face liquid crystal panel and the rear face liquid crystal panel in response to the input I/F signal.

The integral memory includes color information on R, G, B respectively for the front face liquid crystal panel and the rear face liquid crystal panel.

Further, it is possible to provide an external memory separately from the inner memory of the timing controller (TCON) Further, a luminance distribution table which corresponds to display property (for example, B-V property) of the liquid crystal panel may be written in the external memory and the luminance distribution table of the external memory is transferred to the integral memory at the time of supplying the power source. Due to such a constitution, it is possible to provide the general-use property to the TCON board with respect to liquid crystal panels having various display characteristics.

Although the description has been made with respect to the example in which the display is made by overlapping two sheets of liquid crystal panels, by overlapping three or more liquid crystal panels and by allowing these liquid crystal panels to perform displays by dividing the hierarchical information in sequence in the same manner as a case in which two sheets of liquid crystal panels are overlapped between the respective panels, it is possible to realize the three-dimensional display.

### BRIEF DESCRIPTION OF DRAWINGS

FIG. 1 is a view showing the constitution of an embodiment 1 of a display device according to the present invention which uses two sheets of liquid crystal panels and the exchange of signals in the embodiment 1;

FIG. 2 is a view showing the internal constitution of a timing controller indicated in FIG. 1;

FIG. 3 is a view showing the system constitution when two sheets of liquid crystal panels are used;

FIG. 4 is a view showing the internal constitution of the timing controller which realized an embodiment 2 of the present invention;

FIG. 5 is a view showing an example of a luminance distribution table of the embodiment 2 according to the present invention;

FIG. 6 is view showing the constitution of the luminance distribution table of the embodiment 2 according to the present invention;

FIG. 7 is a view showing the luminance distribution table stored in the inside of an integral memory;

FIG. 8 is a view for explaining an embodiment 3 of the present invention which includes a ROM which stores a luminance distribution table outside a timing controller;

FIG. 9 is an example of a sequence at the time of downloading a content of the external ROM shown in FIG. 8 into a RAM which is incorporated in the timing controller;

FIG. 10 is a view for explaining the constitution of an external memory in an embodiment 4;

FIG. 11 is a constitutional view which halves the capacitance of the external memory compared to the capacitance of the external memory shown in FIG. 10 by using the luminance distribution table in common by RGB;

FIG. 12 is a constitutional view which halves the capacitance of the external memory compared to the capacitance of the external memory shown in FIG. 11 by using the luminance distribution table in common by front and rear panels;

FIG. 13 is a timing chart in which RGB signals and a Z signal are synchronized;

FIG. 14 is a timing chart in which the Z signal has a phase thereof shifted by one pixel compared to the Z signal shown in FIG. 10;

FIG. 15 is a block diagram of a timing controller which is formed by incorporating a phase adjusting circuit which eliminates the phase lag shown in FIG. 14 into the timing controller having the constitution shown in FIG. 4;

FIG. 16 is a timing chart which exhibits a phase lag of less than one line in the same manner as FIG. 14;

FIG. 17 is a view for explaining a constitutional example of the phase adjusting circuit;

FIG. 18 is a view showing the constitution in an embodiment 6;

FIG. 19 is a graph showing a change of the voltage-luminance property attributed to temperature when the voltage is taken on an axis of abscissas and the luminance is taken on an axis of ordinates;

FIG. 20 is a circuit constitutional view of a gray scale setting circuit;

FIG. 21 is a view showing the whole constitution of an embodiment 7;

FIG. 22 is a circuit constitutional view of a gray scale setting circuit in the embodiment 7; and

FIG. 23 is a circuit constitutional view of a gray scale setting circuit in an embodiment 8.

### DETAILED DESCRIPTION OF THE INVENTION

Hereinafter, embodiments of the present invention are explained in detail in conjunction with drawings which show these embodiments. In these embodiments, the explanation is made with respect to a display device which can provide a stereoscopic display to a viewer with the structure in which two sheets of liquid crystal panels are overlapped to each other.

[Embodiment 1]

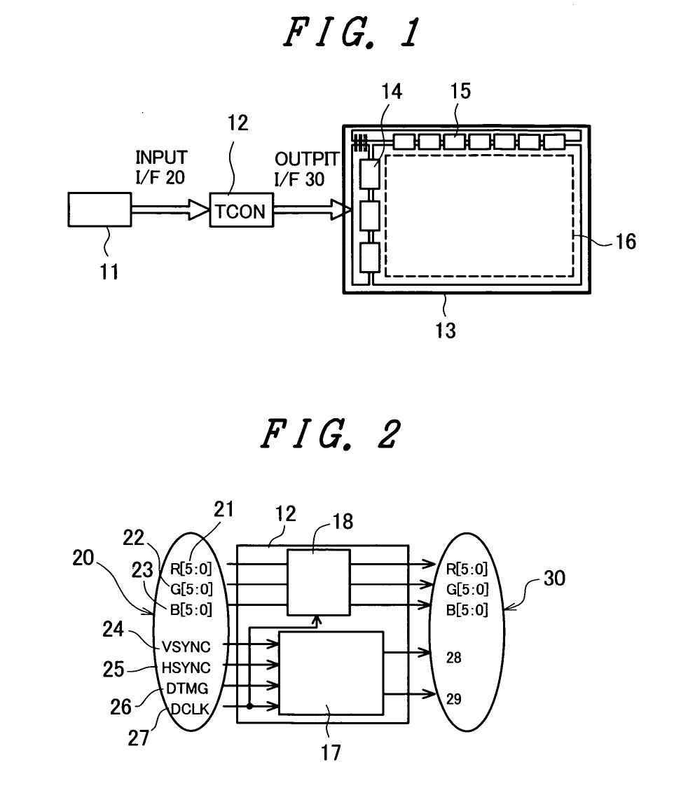

FIG. 1 is a view showing the constitution of an embodiment 1 of a display device according to the present invention which uses two sheets of liquid crystal panels and the exchange of signals in the embodiment 1. As shown in FIG. 1, usually, in the display device which uses the liquid crystal panels, first of all, input I/F signals 20 which are constituted of display signals (hereinafter also referred to as display data) of RGB, a vertical synchronizing signal (VSYNC), a horizontal synchronizing signal (HSYNC), a data-timing synchronizing signal (DTMG) and a dot clock (DCLK) which transfers these signals are inputted to one timing controller (TCON) 12 from one signal source 11.

The timing controller (TCON) 12 allows a liquid crystal module 13 to display an image on a display region 16 thereof by converting the inputted I/F signal 20 from the signal source 11 into I/F signals 30 for liquid crystal drivers (scanning drivers 14(referred to as gate drivers in an active liquid crystal module which is constituted of thin film transistors), data drivers 15 (referred to as source drivers or drain drivers in the active liquid crystal module which is constituted of the thin film transistors)) which are arranged on a liquid crystal module 13.

FIG. 2 is a view showing the internal constitution of the timing controller (TCON) 12 shown in FIG. 1.

The input I/F signals 20 are a group of signals which are constituted of display data 21 of R (red), display data 22 of G (green), display data 23 of B (red), the vertical synchronizing signal (VSYNC) 24, the horizontal synchronizing signal (HSYNC) 25, the synchronizing signal (DTMG) 26 of data timing, and the dot clock (DCLK) 27 which transfers these signals. Here, it is needless to say that colors may be expressed using yellow, cyan, magenta and the like.

The timing controller (TCON) 12 includes a driver I/F signal generating circuit 17 and a delay circuit. To the driver I/F signal generating circuit 17, among the group of signals of the input I/F signals 20, the vertical synchronizing signal (VSYNC) 24, the horizontal synchronizing signal (HSYNC) 25, the synchronizing signal (DTMG) 26 of the data timing and the dot clock (DCLK) 27 which transfers these signals are inputted. On the other hand, the timing controller (TCON) generates and outputs a source driver control signal 28 which constitutes a data driver control signal, and a gate driver control signal 29 which constitutes a scanning driver control signal. Further, a R signal 21, a G signal 22 and a B signal 23 are outputted to the liquid crystal driver by way of a delay circuit 18.

The R signal 21, the G signal 22 and the B signal 23 which are outputted by way of the delay circuit 18, the source driver control signal 28, and the gate driver control signal 29 constitute a group of signals of the output I/F signal 30. Here, the delay circuit 18 is a circuit which matches phases of the source driver control signal 28 and the gate driver control signal 29 which are generated from the driver I/F signal generating circuit 17 with phases of the signals R, G, B, and the dot clock (DCLK) 27 out of the group of signals of the input I/F signal 20 is inputted to the delay circuit 18.

Here, first of all, the explanation is made with respect to the embodiment in which the timing controller (TCON) 12 is used for respective sheets of liquid crystal panels.

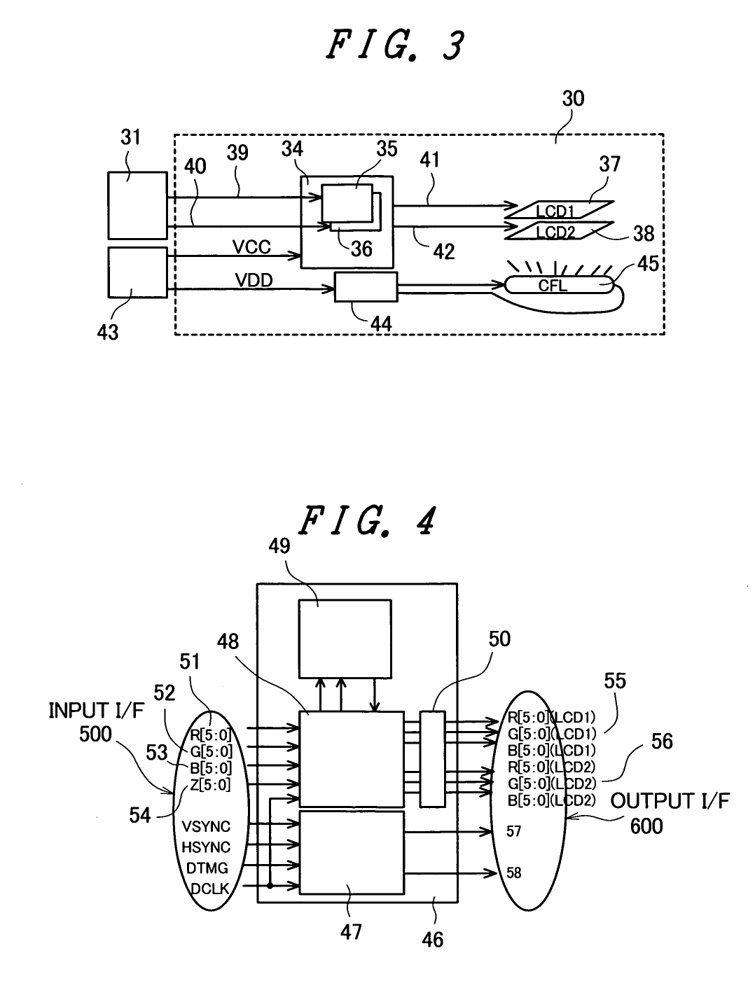

FIG. 3 is a view which shows the system constitution when two sheets of liquid crystal panels are used. Further, a portion 30 which is surrounded by a dotted line is a portion which is constituted as a display device. The display device 30 is connected to the signal source (image signal source) 31 and the DC power source 43 from the outside.

In such a constitution, the signals are supplied to two sheets of liquid crystal panels respectively from the signal source 31. Further, two timing controllers (TCON) 35, 36 are mounted on the TCON board 34, and these timing controllers (TCON) 35, 36 are connected to the front face liquid crystal panel 37 and the rear face liquid crystal panel 38 respectively. Here, in this embodiment, the timing controllers 35, 36 use the timing controller (TCON) having the constitution shown in FIG. 2.

To be more specific, to the front face liquid crystal panel 37, the group of signals of the input I/F signals 39 for the front face liquid crystal panel 37 is outputted from the signal source 31. Then, the group of signals of the input I/F signals 39 for the front face liquid crystal panel 37 is converted into the group of signals of the output I/F signals 41 for the front face liquid crystal panel 37 by the timing controller (TCON) 35 and are inputted to the front face liquid crystal panel 37. In the same manner, to the rear face liquid crystal panel 38, the group of signals of the input I/F signals 40 for the rear face liquid crystal panel 38 is outputted from the signal source 31. Then, the group of signals of the input I/F signals 40 for the rear face liquid crystal panel 38 are converted into the group of signals of the output I/F signals 42 for the rear face liquid crystal panel 38 by the timing controller (TCON) 36 and are inputted to the rear face liquid crystal panel 38.

On the other hand, a DC power source 43 supplies a voltage VCC to the TCON board 34 and supplies a voltage VDD to the inverter board 44. The inverter board 44 is connected to a light source (backlight) 45 such as a CFL, an LED or the like. The light source 45 is arranged when the transmissive liquid crystal panel is arranged at a rear face of the display device as in the case of this embodiment. That is, the light source 45 may be constituted as a so-called side light type which arranges a light guide plate on a back surface of the rear-face liquid crystal panel and arranges a light source on a side of the light guide plate or a so-called direct type which arranges a light source right below a rear face of the liquid crystal panel. It is needless to say that the light source 45 may be constituted of other type. Here, since the light source 45 is arranged on the back surface of the liquid crystal panel, the light source 45 may be referred to as a backlight device.

In such a constitution, in the signal source 31, the respective data of R,G,B and the vertical, horizontal and DTMG synchronizing signals for operating the front face liquid crystal panel (LCD1) are generated. In the same manner, in the signal source 31, the respective display data of R,G,B and the vertical, horizontal and DTMG synchronizing signals for operating the rear face liquid crystal panel (LCD2) are generated.

Accordingly, while the signal source which generates display data for two systems becomes necessary in the embodiment 1, a graphic controller for controlling image signals performs outputting of one system in general, the outputting is realized by using two graphic controllers together. Further, recently, there has been known a technique which allows one graphic controller to perform the outputting of two systems. The outputting of the graphic controller may be realized using such graphic controller. In this embodiment, the connection between the signal source 31 and the timing controllers (TCON) 35, 36 requires two systems and hence, connectors and cables for two systems become necessary.

[Embodiment 2]

In the embodiment 1, the group of signals consisting of input I/F signals is necessary for two sheets of liquid crystal panels respectively and a display is performed using two timing controllers (TCON). Accordingly, two sets of I/F signal cables and connectors for the groups of signals consisting of input I/F signals become necessary and hence, the embodiment 1 doubles a cost of parts compared to a case in which one timing controller (TCON) is used. Then, in this embodiment 2, the constitution of the liquid crystal display device which can reduce the manufacturing cost compared to the constitution of the embodiment 1 is considered.

First of all, the constitution which sets the number of the timing controllers (TCON) to one is considered. To explain hereinafter, it is extremely effective to constitute the display device which can perform the stereoscopic display using one timing controller (TCON). However, inventors of the present invention have considered that even when the number of the timing controllers (TCON) is set to one, there is no change with respect to a point that the transmission and reception of signals similar to the transmission and reception of signals in the embodiment 1 are performed for two sheets of liquid crystal panels respectively and hence, the number of terminals of the timing controller (TCON) is not changed compared to the case in which two timing controller (TCON) are used whereby a cost cannot be reduced.

For example, when the signals R, G, B are inputted to one sheet of liquid crystal panel, assuming a case in which the 6-bits information is inputted for each one of R, G, B, as an example, the number of signals (the number of terminals) of 18 becomes necessary. Accordingly, when two sheets of liquid crystal panels are operated, it is necessary to set the number of signals to 36.

In general, to generate the gray scales of the liquid crystal display device, it is necessary to provide a display of approximately 64 gray scales in which R, G, B respectively have 6-bits information. In this case, the number of input terminals becomes 18 in total, wherein 6 terminals for each of R, G, B in the same manner as the number of bits. When two sheets of liquid crystal panels are provided, it is necessary to provide 36 input terminals for two systems with 64 gray scales, wherein each one of R, G, B has 6-bits information.

Accordingly, in the constitution of the embodiment 2, the constitution which adds the hierarchical information on the group of signals of the input I/F signal from the outside of the liquid crystal display device is considered. The hierarchical information (Z signal) which constitutes the depth information is information for distributing the luminances of R, G, B to two sheets of liquid crystal panels. In this embodiment, in place of giving the signals of R, G, B to two sheets of liquid crystal panels respectively, by adopting the R, G, B signals and the depth information (Z signal) which are common with respect to two sheets of liquid crystal panels as signals in the group of signals of the input I/F signal, the number of terminals of the timing controller (TCON) is decreased thus providing the display device which can reduce the manufacturing cost.

To be more specific, in the display device of the embodiment 2, by inputting the R, G, B signals and the Z signal which are common with respect to two sheets of liquid crystal panels, when each one of the R, G, B, Z signals is constituted of 6-bits information, for example, the number of signals of the input I/F signal can be reduced to 24 compared to the embodiment 1 and, at the same time, it is possible to allow viewer's eyes to observe the pixel formed based on color information of R, G, B as if the pixel is positioned between the front face and the rear face in the same manner as the embodiment 1.

Next, the Z signal which indicates the hierarchical information is explained. For example, with respect to two sheets of liquid crystal panels, when the position of the rear face liquid crystal panel is preliminarily defined as 00 in hexadecimal notation and the position of the front face liquid crystal panel is defined as 3F in hexadecimal notation, the Z signal is positional information which expresses the position (depth) between these two sheets of liquid crystal panels. For example, by giving the Z signal in which the front face liquid crystal panel is defined as 3F in the hexadecimal notation and the rear face liquid crystal panel is defined as 00 in hexadecimal notation, it is possible to use only one side (front face) of the two sheets of liquid crystal panels. Further, by giving the Z signal in which the front face liquid crystal panel is defined as 00 and the rear face liquid crystal panel is defined as 3F in hexadecimal notation, it is possible to use another end surface (rear face) of the two sheets of liquid crystal panels to the contrary.

For example, when the Z signal is constituted of 6-bits information, this state is equivalent to 64 division of the hierarchy (depth) between two sheets of liquid crystal panels. That is, this state is equivalent to 64 division of a positional space between the rear face liquid crystal panel and the front face liquid crystal panel. Here, it is possible to allow each gray scale of R, G, B to have 5-bits information and, at the same time, it is also possible to allow each gray scale of R, G, B to have 7-bits or more information. The number signal inputting is determined based on the number of gray scales of the R, G, B.

In this embodiment, although each one of the R,G,B signals and the Z signal has the 6-bits information, the number of bits may be 1 bit or more and there is no upper limit particularly with respect to the number of bits. When the Z signal has 1 bit information, 0 indicates a signal for the rear face liquid crystal panel and 1 indicates the signal for the front face liquid crystal panel. For example, when the Z signal has the 8-bits information, the distance between the front face liquid crystal panel and the rear-face liquid crystal panel can be divided in 256. When the Z signal has 2-bits or more information, by reference to a luminance distribution table in the inside of the display device described later, the luminance is distributed to the front face liquid crystal panel and the rear face liquid crystal panel. Although the interface adopts a CMOS method, the interface may adopt a deferential transfer method such as LVDS.

As has been explained above, the Z signal is the information indicating the positional space defined between the front face liquid crystal panel and the rear face liquid crystal panel which are displayed by R, G, B, wherein the positional space can be finely divided by increasing the number of bits of the Z signal. For example, by allowing the Z signal to have the 8-bits information, the positional space between the front face liquid crystal panel and the rear face liquid crystal panel is divided in 256, while by allowing the Z signal to have 10-bits information, the positional space between the front face liquid crystal panel and the rear face liquid crystal panel is divided in 1024. Here, since two sheets of liquid crystal panels are arranged in a state that these liquid crystal panels are overlapped from a front face, the displayed image is observed as an overlapped image from a viewer.

A stereoscopic vision attributed to an image display can be achieved by controlling the R, G, B luminances of the front face liquid crystal panel and the rear face liquid crystal panel in response to the stereoscopic information of an object. The inputted Z signal is used for distributing R, G, B luminance (gray scale) information with respect to the front face liquid crystal panel and the rear face liquid crystal panel.

FIG. 4 is a view showing the internal constitution of the timing controller (TCON) which realizes the embodiment 2 of the present invention. The timing controller (TCON) of this embodiment has a feature in that the group of signals of the input I/F signal includes, besides color information which are expressed by R, G, B signals common in two sheets of liquid crystal panels, the Z signal as the depth information.

The timing controller (TCON) 46 is constituted of a driver I/F signal generating circuit 47, and an address generating circuit 48, an integral memory 49 and a delay circuit 50.

From the outside of the display device, a R signal 51, a G signal 52, a B signal 53 which are used in common with respect to two sheets of liquid crystal panels and a Z signal 54 which indicates the depth information between two sheets of liquid crystal panels are inputted to an address generating circuit 48 of the timing controller (TCON) 46. Further, from the outside of the display device, a vertical synchronizing signal (VSYNC), a horizontal synchronizing signal (HSYNC), a data-timing synchronizing signal (DTMG), and a dot clock (DCLK) which transfers these signals are inputted to a driver I/F signal generating circuit 47 of the timing controller (TCON) 46. The driver I/F signal generating circuit 47 generates a source driver control signal 57 and a gate driver control signal 58 which are used in common in two sheets of liquid crystal panels and these control signals 57, 58 are respectively outputted to two sheets of liquid crystal panels.

The address generating circuit 48, based on the received R signal 51, G signal 52, B signal 53 and Z signal 54 indicative of the depth information, references the luminance distribution table stored in an internal memory 49, and outputs the signals 55, 56 of the R,G,B signals to the front face liquid crystal panel and the rear face liquid crystal panel respectively. Also with respect to this timing controller (TCON) 46, to match phases of a source driver control signal 57 and a gate driver control signal 58 which are generated in the driver I/F signal generating circuit 47 and are used in common in a front face liquid crystal panel (LCD1) and a rear face liquid crystal panel (LCD2) with phases of signals R, G. B, the dot clock (DCLK) is inputted to the address generating circuit 48, while R, G, B signals 55, 56 which are generated by the address generating circuit 48 are outputted to two sheets of liquid crystal panels respectively by way of the delay circuit 50.

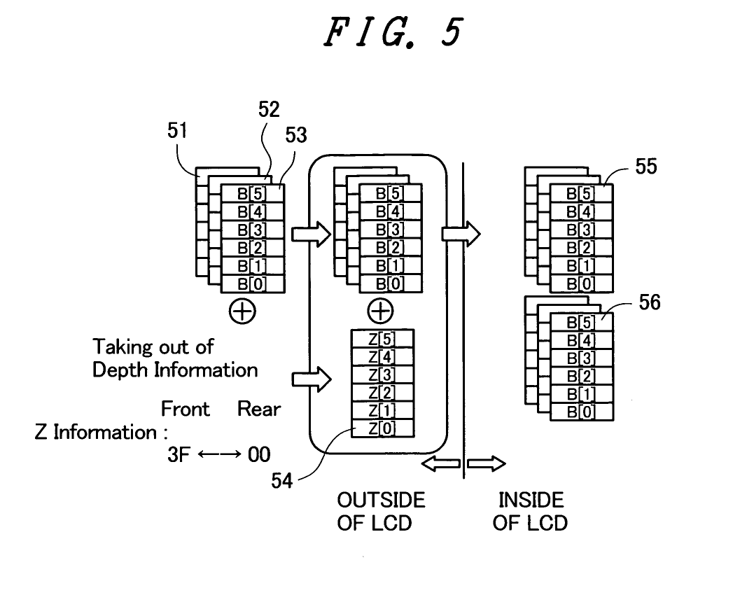

Next, the way of thinking of the R, G, B signals and the Z signal of this embodiment are explained in conjunction with FIG. 5.

FIG. 5 is a view showing one example of a luminance distribution table of the embodiment 2 of the present invention. A left side of FIG. 5 shows the outside of a so-called liquid crystal display device, while a right side of FIG. 5 shows the inside of the liquid crystal display device. In this embodiment, signals which are relevant to the image information inputted to the liquid crystal display device include, as indicated by symbols 51, 52, 53 shown in FIG. 5, data of gray scale information showing the magnitude of the luminance with respect to R, G, B respectively. For example, assuming the pixel which is constituted of R, G, B of the liquid crystal panel as a unit, the information on the luminance of the image is displayed based on the information such as (R[0 to 63 gray scales], G[0 to 63 gray scales], B[0 to 63 gray scales]) with respect to one unit. Here, 0 indicates the low luminance gray scale and 63 indicates the high luminance gray scale.

Then, the Z signal which expresses the depth information indicates the data of the hierarchical information of the position, wherein the depth information is indicated based on Z[0 to 63]. With respect to the Z signal, O indicates the position of the rear face liquid crystal panel and 63 indicates the position of the rear face liquid crystal panel. It is needless to say that, to the contrary, with respect to the Z signal, 63 indicates the position of the front face liquid crystal panel and 0 indicates the position of the rear face liquid crystal panel.

Then, in this embodiment, using such R, G, B signals and Z signal as one set, as described later, the respective R, G, B signals 55, 56 (gray scale signals) which are transmitted to the front face liquid crystal panel and the rear face liquid crystal panel are generated in the inside of the TCON board by reference to the luminance distribution table and are outputted.

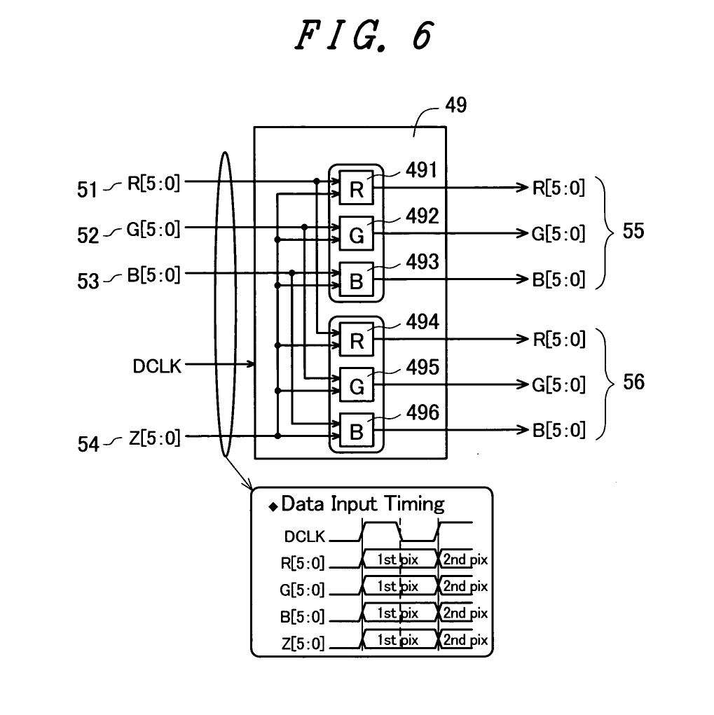

Next, in conjunction with FIG. 6, the explanation is made with respect to a step at which the respective R, G, B signals are generated with respect to two sheets of liquid crystal panels by reference to the luminance distribution table. FIG. 6 is a view showing the constitution of a memory of the embodiment 2 of the present invention. In this embodiment, as shown in FIG. 6, the integral memory 49 includes memories each of which stores one luminance distribution table for each color R, G, B. FIG. 6 shows a case of the display device which uses two sheets of liquid crystal panels, wherein the integral memory 49 is constituted of six (R, G, B×2) memories in total. The input timing of the Z signal 54 is equal to the input timing of the R, G, B signals 51, 52, 53, and the luminance distribution table data stored in the memories are read out using the R, G, B signals and the Z signal as read address. The luminance distribution table data read out from the memories by the read address constitutes the display data of R, G, B.

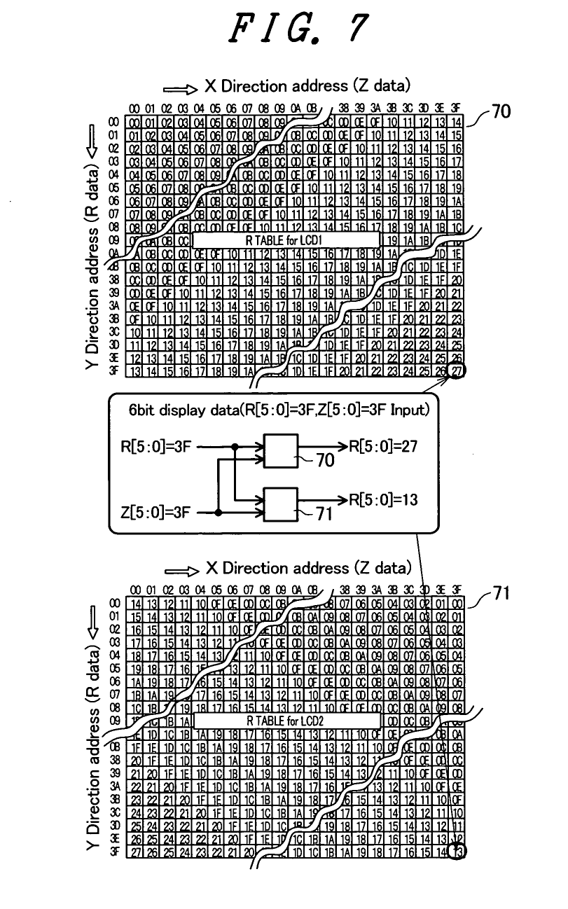

FIG. 7 is a view showing the content of the luminance distribution table stored in the integral memory. For example, numeral 70 indicates the R luminance distribution table for the front face liquid crystal panel (LCD1) and numeral 71 indicates the R luminance distribution table for the rear face liquid crystal panel (LCD2).

As indicated by numeral 70 shown in FIG. 7, in the luminance distribution table of this embodiment, the data on the Z signal, that is, the depth (hierarchy) is indicated in the X direction address, while the data in the Y direction indicates the information on the tone of the R signal, for example.

FIG. 7 shows an example in which the R, G, B signals and the Z signal of the input data and the R, G, B signals of the output data are constituted of 6-bits information respectively. Further, the luminance distribution table data stored in the integral memory is arbitrary.

To illustrate a specific example, the example is as follows. For example, assuming that R[5:0]=3F is inputted as the R signal from the outside and Z[5:0]=3F is inputted as the Z signal from the outside as shown in FIG. 7, the timing controller (TCON) outputs 27 (hex) to the front face liquid crystal panel (LCD1) and 00 (hex) to the rear face liquid crystal panel (LCD2) by reference to the R luminance distribution table 70 for the front face liquid crystal panel (LCD1) and the R luminance distribution table 71 for the rear face liquid crystal panel (LCD2), and eventually, can distribute the output data into the output data of two systems using the input data of one system of RGB 1 and the Z signal.

In this embodiment, with the provision of the luminance distribution table and the Z signal, it is possible to obtain an advantageous effect that even when the number of the liquid crystal panels is increased, an input data bus to the timing controller (TCON) is not increased. Further, so long as the display is performed using two or three liquid crystal panels, it is possible to sufficiently obtain such an advantageous effect by using a single timing controller of a general QFP package. Further, it is also possible to expect the reduction of cost attributed to the reduction of the number of parts of a product, the miniaturization of an area of the TCON substrate and the like.

[Embodiment 3]

FIG. 8 is a view for explaining an embodiment 3 of the present invention which includes a ROM in which the luminance distribution table is stored outside a timing controller (TCON) 82. Since the content of a ROM (external ROM) 81 which constitutes an external memory can be rewritten from a ROM writer 86 outside the display device, it is unnecessary to develop various timing controllers (differing in the content of the luminance distribution table) which are necessary due to the difference in the display characteristic (for example, B-V characteristic or the like) of the display device.

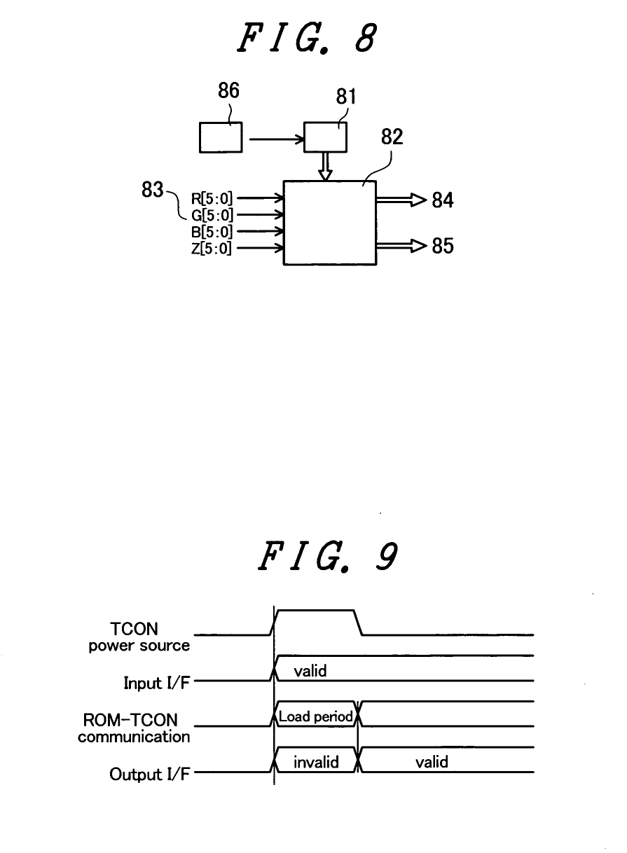

Here, FIG. 9 shows an example of a sequence at the time of downloading (transferring) the content of the external ROM81 in FIG. 8 to the RAM incorporated in the timing controller (TCON) 82.

[Embodiment 4]

In the embodiment 4, the constitution of the external memory in the embodiment 3 is explained.

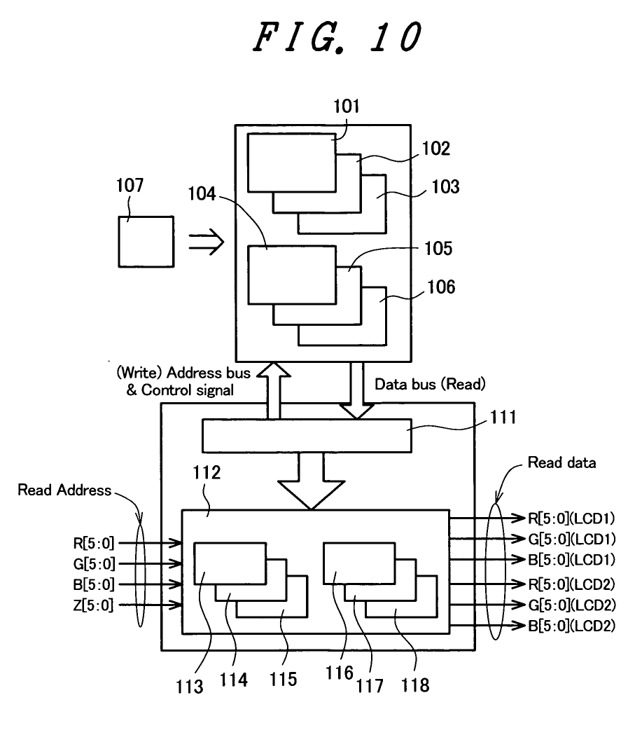

As exactly shown in FIG. 10, by providing a memory 100 having the capacitance (amounting to 6 sheets (6 kinds) of luminance distribution tables) equal to the capacitance of a memory 112 in the inside of the timing controller (TCON) 110 outside the timing controller (TCON) 110, it is possible to provide the luminance distribution tables which are suitable for respective display characteristics of R, G, B of the front and rear liquid crystal panels. In this case, in the inside of the external memory 100, a front face R luminance distribution table 101, a front face G luminance distribution table 102, a front face B luminance distribution table 103, a rear face R luminance distribution table 104, a rear face G luminance distribution table 105 and a rear face B luminance distribution table 106 are stored.

Although the constitution which includes the external memory 100 in FIG. 10 can provide the display device which exhibits the excellent display characteristics, an expensive large-capacitance storage medium such as a flash memory or the like becomes necessary as the external memory 100. Further, when the communication between the external memory 100 and the timing controller (TCON) 110 is performed using the parallel communication, the number of the address bus and the data bus is added to the number of terminals of the timing controller (TCON) 110 and hence, there exists a possibility that the manufacturing cost is pushed up due to the increase of the number of terminals of the timing controller (TCON) 110.

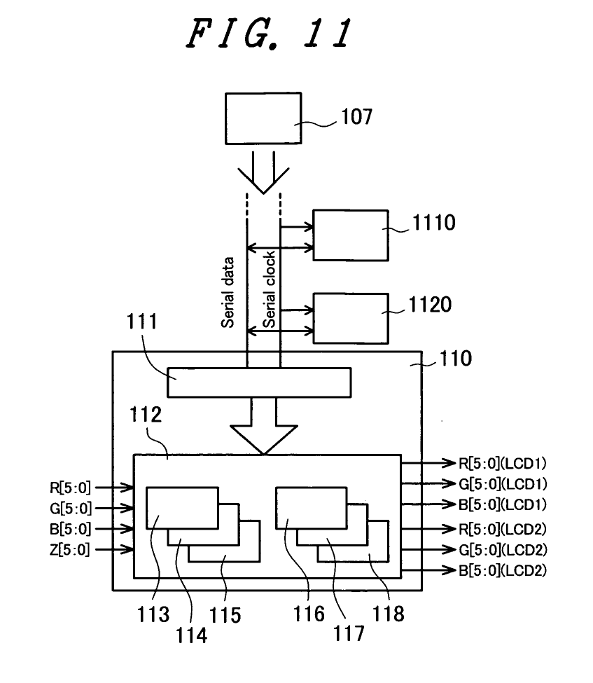

FIG. 11 shows a constitutional example of the external memory which enables the common use of the luminance distribution tables of R, G, B and realizes the three dimensional display using two luminance distribution tables for the front and rear face liquid crystal panels. When each one of R, G, B and Z has the 6-bits information, one sheet of luminance distribution table can be stored in a serial communication memory such as an EEPROM (front face R, G, B luminance distribution table storage EEPROM 1110, rear face R, G, B luminance distribution table storage EEPROM 1120) or the like which is of small capacitance and can be relatively inexpensively manufactured. According to FIG. 11, the increase of the number of terminals of the timing controller (TCON) can be suppressed to two and the number of EEPROM is two and hence, a possibility that the manufacturing cost is pushed up with respect to the constitution shown in FIG. 10 can be eliminated.

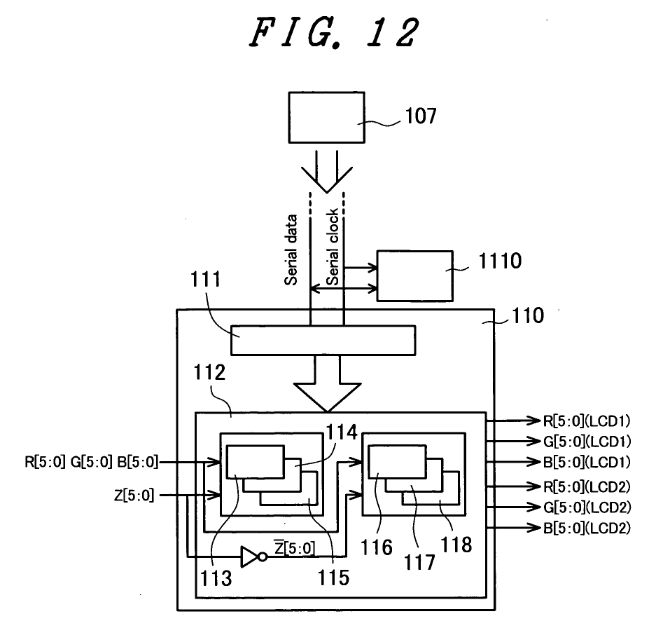

FIG. 12 shows an example in which two sheets of luminance distribution tables for front and rear face liquid crystal panels shown in FIG. 11 are formed into a single sheet of luminance distribution table which is used by the front and rear face liquid crystal panels in common. The luminance distribution table for the front face liquid crystal panel and the luminance distribution table for the rear face liquid crystal panel, as shown in FIG. 7, has the property that the three dimensional display can be obtained by performing a mirror inversion in the X direction address (Z data). By making use of this property, as shown in FIG. 12, it is possible to allow one sheet of the luminance distribution table to be used in common by the front and rear face liquid crystal panels. In FIG. 12, the luminance distribution tables of the front-face R, G, B which are stored in one EEPROM are down loaded (rewritten) to six integral memories in total and, at the time of reading, the above-mentioned mirror inversion of the X direction address (Z data) is realized by inverting the Z signal only in the back-face RGB integral memories.

[Embodiment 5]

Next, the explanation is made with respect to the embodiment 5 of the present invention. In the embodiments 2 and 3, to enable the display of three dimensional image using two sheets of liquid crystal panels, the R, G, B signals and the Z signal are used and the timing controller (TCON) which uses these data as inputs is developed. When a PC is used as the signal source, it is found that, different from the input timing which is expected originally, phases (coordinates position of the pixel) of the R, G, B signals and the Z signal are shifted from each other.

Accordingly, in this embodiment, based on the understanding that it is a requisite that the R, G, B signals and the Z signal have the same phase (coordinate position of the pixel being equal) in the three dimensional display which uses the R, G, B signals and the Z signal, the display device which satisfies such a requisite is provided.

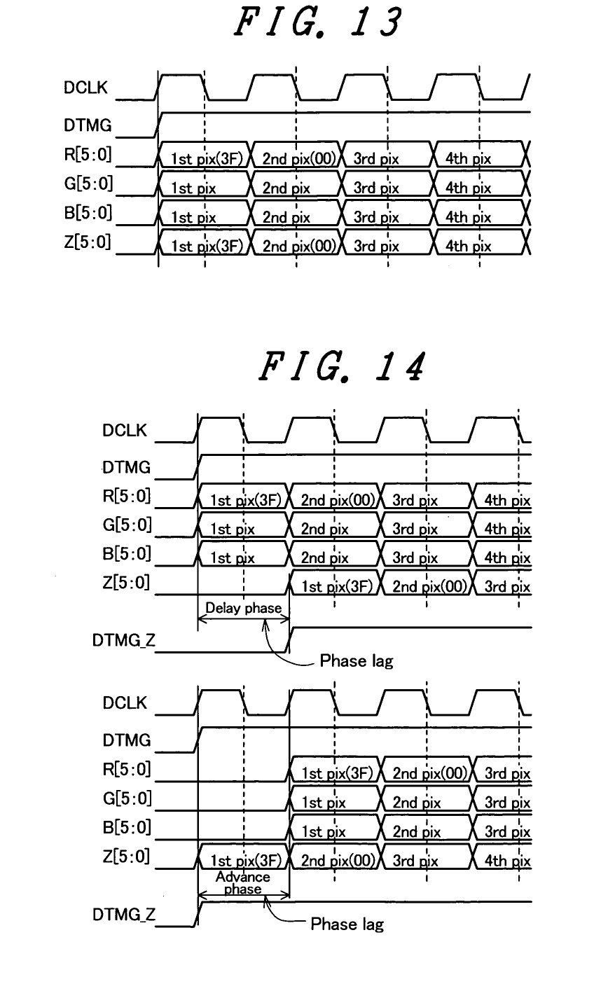

FIG. 13 is a timing chart in which the R, G, B signals and the Z signal are synchronized. The first and second pixel portions of the R signal and the Z signal are inputted to the timing controller (TCON) in order of 3F, 00 respectively. FIG. 14 is a timing chart in which the Z signal has a phase thereof shifted by one pixel with respect to the timing shown in FIG. 10.

FIG. 13 is an example of timing chart in which the Z signal has a phase thereof shifted by one pixel with respect to the timing shown in FIG. 14. In conjunction with FIG. 7, originally, as the output data on the second pixel portion, 00 is expected with respect to the front face liquid crystal panel (LCD1) and 14 is expected with respect to the rear face liquid crystal panel (LCD2).

However, when a phase lag exists as shown in an upper portion of FIG. 14, 3F in the first pixel portion of the Z signal input is used and 14 is outputted to the front face liquid crystal panel (LCD1) and 13 is outputted to the rear face liquid crystal panel (LCD2) . In this manner, when there exists the phase lag, it is difficult to obtain the accurate three-dimensional display.

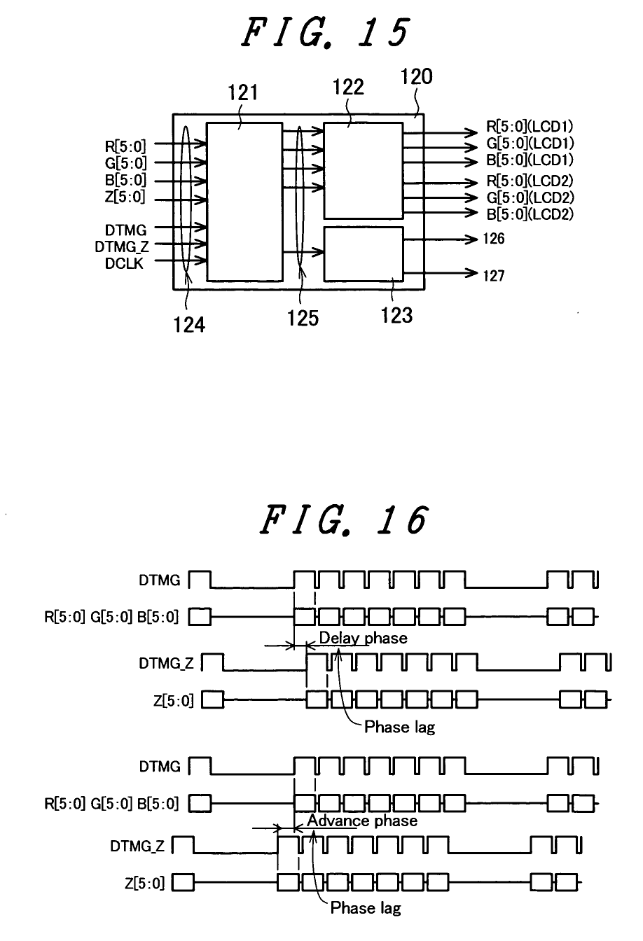

FIG. 15 is a block diagram of the timing controller (TCON) which incorporates a phase adjusting circuit for eliminating the phase lag shown in FIG. 14 therein in the same manner as the timing controller having the constitution shown in FIG. 4. As shown in FIG. 15, at the I/F timing 124 shown in FIG. 14, R, G, B signals and the Z signal are inputted to the phase adjusting circuit 121. Further, signals which are outputted from the phase adjusting circuit 121 are inputted to an integral memory 122 and a driver I/F generating circuit 123 at the I/F timing 125 shown in FIG. 13.

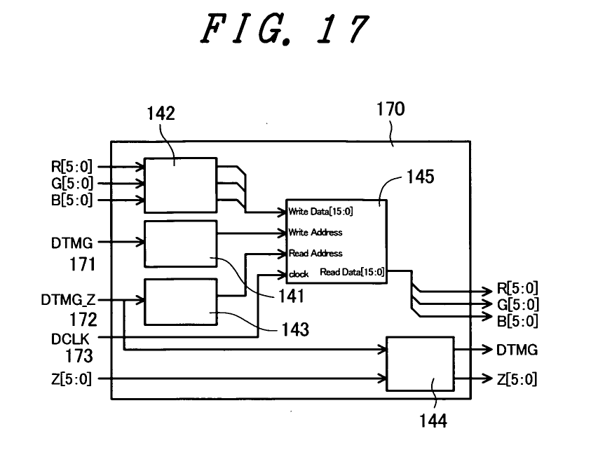

FIG. 16 is a timing chart which expresses the phase lag of less than one line in the same manner as FIG. 14. Further, FIG. 17 is a view for explaining a constitutional example of a phase adjusting circuit 170 which eliminates the phase lag when the Z signal is delayed with respect to the R, G, B signals. The phase adjusting circuit 170 expects a degree of a phase lag amount shown in FIG. 16 and hence, the phase adjusting circuit 170 uses a line memory (2-port RAM) 145 as a recording medium. Here, it is originally desirable to provide an example of the phase adjusting circuit 170 which includes a circuit for detecting the fore-and-aft relationship of a DTMG 171 and a DTMG_Z172 so as to eliminate both of a delay phase and an advance phase, to simplify the explanation made hereinafter, the phase adjusting circuit is limited to the phase adjusting circuit which eliminates the delay phase shown in FIG. 17.

A write address counter 141 is a circuit which is cleared every rising edge of the inputted DTMG 171 and counts up a counter with the DCLK 173. Then, the write address counter 141 outputs the write address to the line memory 145.

The data delay circuit 142 is a delay circuit which matches the timing of write address=0 with the first pixel portions of the R, G, B signals which constitute the input data.

A read address counter 143 is a circuit which is cleared every rising edge of the DTMG_Z172 inputted later and counts up a counter with the DCLK 173. Then, the read address counter 143 outputs the read address to the line memory 145.

The data delay circuit 144 is a delay circuit which matches the read data (R, G, B) of the read address=0 with the first pixel portions of the input data Z.

Further, the DTMG_Z172 is inputted to the driver I/F generating circuit 123 in FIG. 15 and hence, the DTMG_Z172 is outputted while being delayed with an amount equal to the Z signal.

To summarize, this embodiment is characterized in that the embodiment includes the means which eliminates the phase difference between the R, G, B signals and the Z signal, that the phase difference is detected based on DTMG which is synchronized with the R, G, B signals and the DTMG_Z which is synchronized with the Z signal, that the embodiment includes the storage medium which temporarily holds the R, G, B signals (or the Z signal), that the embodiment includes a circuit which generates the write address for the storing medium using the rising edge of the DTMG (or DTMG_Z) inputted previously as the reference, that the embodiment includes a circuit which generates the read address for the storing medium using the rising edge of the DTMG_Z (or DTMG) inputted previously as the reference, and that the R, G, B signals and the Z signal are synchronized by synchronizing the Z signal (or R, G, B signals) which is synchronized with the DTMG_Z (or DTMG) inputted later and the read data attributed to the read address.

In this embodiment, by incorporating the storage medium having a certain capacitance in the timing controller (TCON) by taking the phase difference which is expected to some extent into consideration, this embodiment can cope with signal sources having various phase differences. Further, by allowing this embodiment to cope with various phase differences, this embodiment can cope with various client systems.

Here, in the above-mentioned respective embodiments, the explanation is made with respect to the display device which uses two sheets of liquid crystal panels. However, even when three or more liquid crystal panels are used, by defining the arrangement of the respective liquid crystal panels and the Z signal, it is possible to realize the image display which appears stereoscopically in the same manner as the display device which adopts two sheets of liquid crystal panels.

[Embodiment 6]

Next, the embodiment 6 of the present invention is explained. In this embodiment 6, with respect to the display device which uses two sheets of liquid crystal panels, the manner in which two sheets of liquid crystal panels are influenced by heat which is generated by a light source such as CFL, LED or the like arranged on a back surface of two sheets of liquid crystal panels is taken into consideration.

That is, in the embodiment 6, inventors of the present invention have focused their attentions on the temperature difference attributed to the distance from the light source with respect to the front face (side remote from the light source) liquid crystal panel and the rear face (side close to the light source) liquid crystal panel out of two sheets of liquid crystal panels. Also in the above-described embodiment 2, two luminance distribution tables consisting of the luminance distribution table for the front face liquid crystal panel and the luminance distribution table for the rear face liquid crystal panel are prepared. However, the embodiment 2 is not particularly conscious of two sheets of liquid crystal panels which particularly take the influence to the luminance attributed to the temperature change of the liquid crystal panels into consideration.

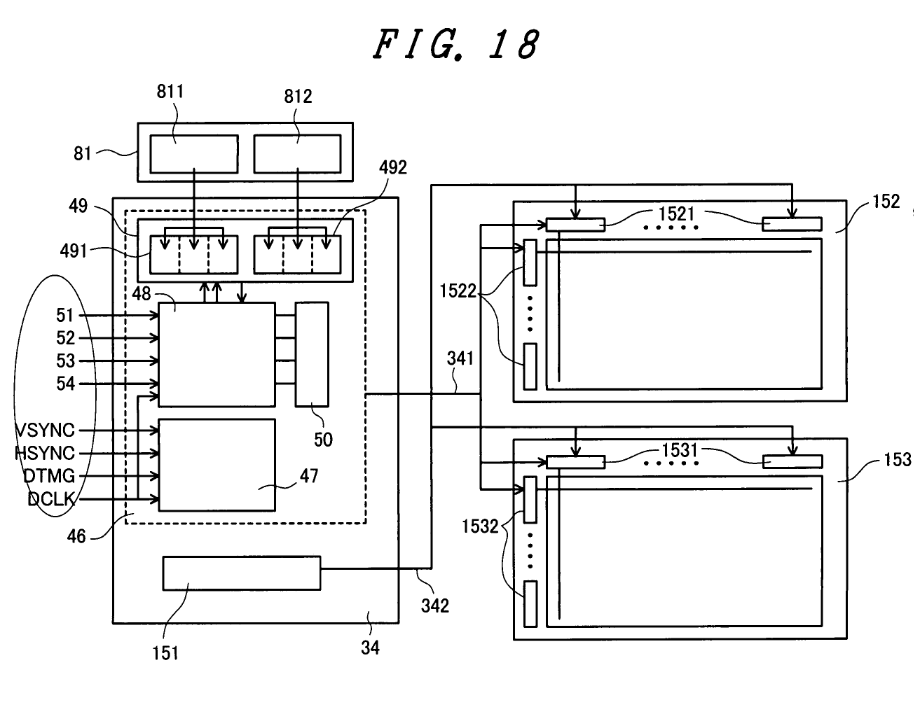

FIG. 18 is a view showing the constitution of this embodiment. As shown in FIG. 18, on a TCON board 34, a timing controller (TCON) 46, and a gray scale setting circuit (γ setting circuit) 151 which is used for setting the voltage-light intensity (luminance) characteristics or the gray scale-luminance characteristics (so-called γ characteristics) are arranged. The timing controller (TCON) 46 includes a driver I/F signal generating circuit 47, an address generating circuit 48, a delay circuit 50, an external memory 81 which stores a front face luminance distribution table 811 and a rear face luminance distribution table 812, a front face internal memory 491 which stores a front face luminance distribution table 811, and a rear face internal memory 492 which stores a rear face luminance distribution table 812 as explained in conjunction with FIG. 4.

Here, in FIG. 18, out put signals from the timing controller (TCON) 46 are collectively indicated by numeral 341. The output signals are constituted of a bundle of signals which are outputted from the driver I/F generating circuit 47 and the delay circuit 50 shown in FIG. 4.

In the embodiments 2 and 3, the luminance for the front face liquid crystal panel 152 and the rear face liquid crystal panel 153 is allocated using the internal memory 491 for the front face liquid crystal panel 152 and the internal memory 492 for the rear face liquid crystal panel 153 which are arranged on the TCON board 34 based on the Z signal. The embodiment 6 is characterized in that the luminance distribution table data which is stored in the internal memories 491, 492 is prepared by taking the change of the voltage and the luminance attributed to the temperature characteristics into consideration.

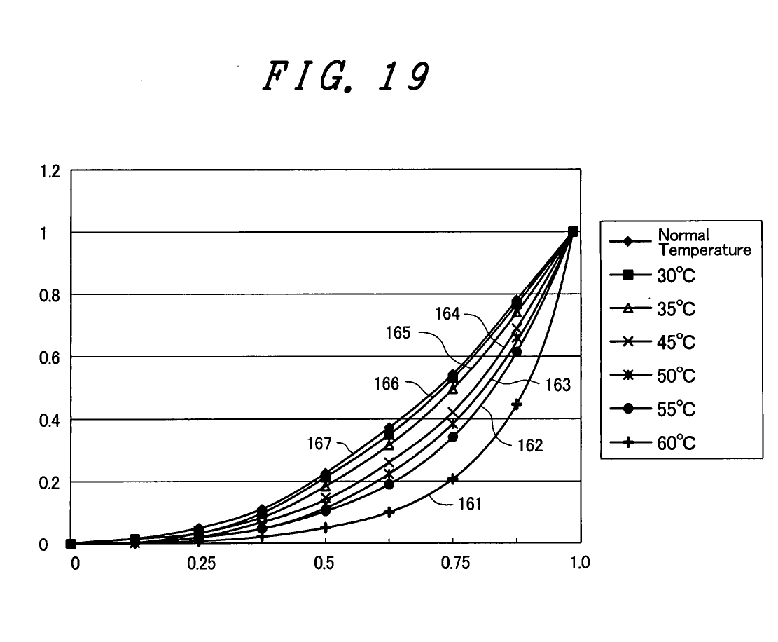

First of all, the degree of the change of the voltage-luminance characteristics of the liquid crystal panels attributed to the change of temperature is explained. FIG. 19 shows the voltage-luminance characteristics, wherein the relative voltage is taken on an axis of abscissas and the relative luminance is taken on an axis of ordinates. In FIG. 19, numeral 161 indicates the voltage-luminance characteristics when the temperature of the liquid crystal panel is 45° C. In the same manner, numeral 162 indicates the voltage-luminance characteristics when the temperature of the liquid crystal panel is 55° C., numeral 163 indicates the voltage-luminance characteristics when the temperature of the liquid crystal panel is 50° C., numeral 164 indicates the voltage-luminance characteristics when the temperature of the liquid crystal panel is 45° C., numeral 165 indicates the voltage-luminance characteristics when the temperature of the liquid crystal panel is 35° C., numeral 166 indicates the voltage-luminance characteristics when the temperature of the liquid crystal panel is 30° C., and numeral 167 indicates the voltage-luminance characteristics when the liquid crystal panel is at a room temperature (approximately 25° C). In this case, the temperature is a value obtained by measuring the temperature of a center portion of the liquid crystal panel on a back light device side when a back light device is arranged on a back surface of the liquid crystal panel. As can be observed from FIG. 19, it is understood that the voltage-luminance characteristics of the liquid crystal panel are considerably changed due to the temperature difference.

When the temperature difference is generated between the front face liquid crystal panel 152 and the rear face liquid crystal panel 153 due to the influence of the heat generated from the light source corresponding to the distance from the light source, as one of means to take the influence of the temperature difference into consideration, in the embodiment 6, there are provided the luminance distribution tables for the front face liquid crystal panel 152 and the rear face liquid crystal panel 153 which take the temperatures of the liquid crystal panels into consideration. The luminance distribution tables are prepared such that the luminance data for the front face liquid crystal panel and the rear face liquid crystal panel can be obtained from the Z signal which constitutes the depth information on the front face liquid crystal panel and the rear face liquid crystal panel based on the voltage-luminance characteristic curve at the predetermined temperature.

Accordingly, when the temperature of the front face liquid crystal panel and the surface temperature of the rear face liquid crystal panel differ, the temperature of the rear face liquid crystal panel and the temperature of the front face liquid crystal panel are measured preliminarily, and the rear face luminance distribution table and the front face luminance distribution table are prepared and used based on the voltage-luminance characteristic curves which conform to the respective temperature characteristics, whereby it is possible to obtain the display having the stereoscopic vision even when the surface temperature differs between the rear face and the front face.

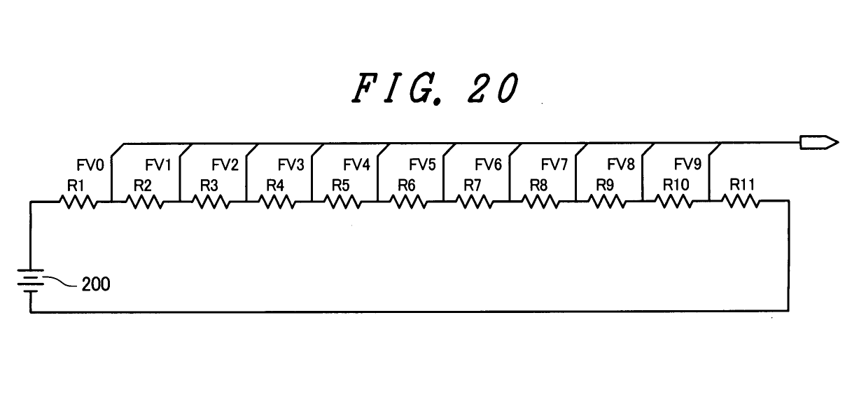

Next, the constitution of the gray scale setting circuit 151 is explained. FIG. 20 is a view showing the circuit constitution of the gray scale setting circuit 151 of the embodiment 6.

As shown in FIG. 20, the gray scale setting circuit is configured such that a resistor R1, a resistor R2, . . . , a resistor R10, a resistor R11 are connected to a power source 200 in series thus performing the resistance division so as to generate voltages V0, V1, . . . , V8, V9, and these voltages are outputted to the liquid crystal drivers.

The gray scale setting circuit 151 is a circuit for generating the gray scale reference voltages for determining the actual voltages applied to the liquid crystal panel in response to gray scale signal outputted from the timing controller (TCON) 46. The gray scale reference voltages 342 which are outputted from the gray scale setting circuit 151 are supplied to a source driver 1521 of the front face liquid crystal panel 152 and a source driver 1531 of the rear face liquid crystal panel 153 respectively. Here, numeral 1522 indicates a gate driver of the front face liquid crystal panel 152, and numeral 1532 indicates a gate driver of the rear face liquid crystal panel 153. To these gate drivers 1522, 1532, a gate driver control signal of an output I/F signal 341 is supplied from the TCON board 34.

Due to the constitution of this embodiment, even when the surface temperature differs between the front face panel and the rear face panel, by providing the luminance distribution tables for the front face panel and the rear face panel independently, the luminance distribution table which conforms to the temperature change can be selected thus providing the display device which can obtain the luminances independently with respect to the front face panel and the rear face panel.

[Embodiment 7]

In the embodiment 6, the explanation is mainly made with respect to the constitution which provides the luminance distribution tables separately to the front face liquid crystal panel 152 and the rear face liquid crystal panel 153. However, such preparation of two kinds of luminance distribution tables increases the capacitance or the number of the external memories which store the luminance distribution tables and hence, the manufacturing cost of the memories is pushed up thus eventually pushing up the manufacturing cost of the whole display device.

Accordingly, in the embodiment 7, as has been explained in conjunction with FIG. 12 which shows the embodiment 4, one luminance distribution table is used in common, and a gray scale setting circuit 154 for a front face liquid crystal panel 152 and a gray scale setting circuit 155 for a rear face liquid crystal panel 153 are provided to the TCON board 34, and gray scale reference voltages are separately generated for the front face liquid crystal panel 152 and the rear face liquid crystal panel 153 respectively.

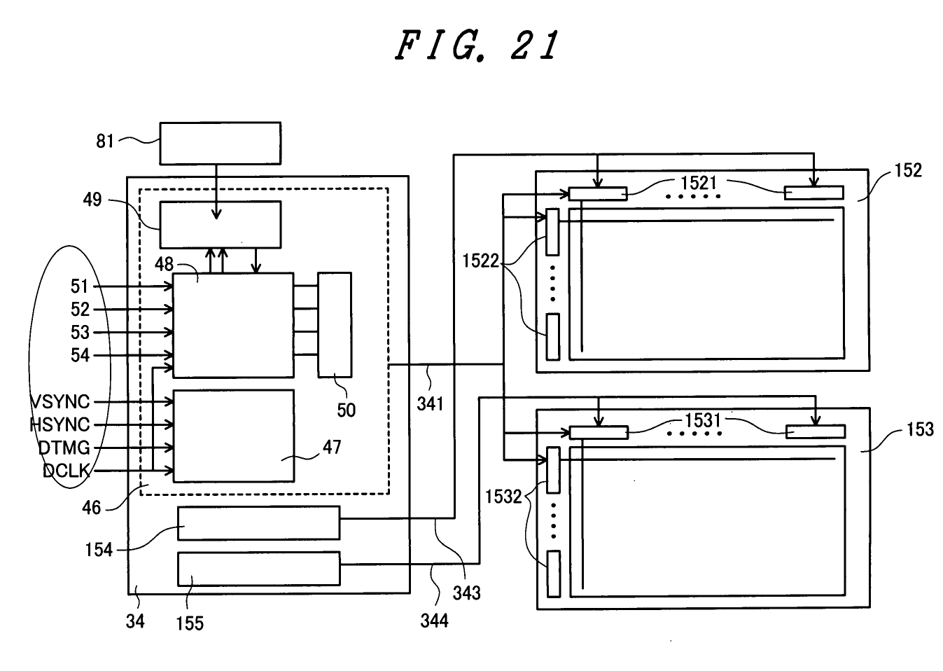

FIG. 21 is a view showing the whole constitution of the embodiment 7. By providing the gray scale setting circuits 154, 155 in two systems for the front face liquid crystal panel, even when one kind of luminance distribution table is provided, it is possible to apply the separate gray scale reference voltages with respect to the gray scale signal applied in common from the timing controller (TCON) 46.

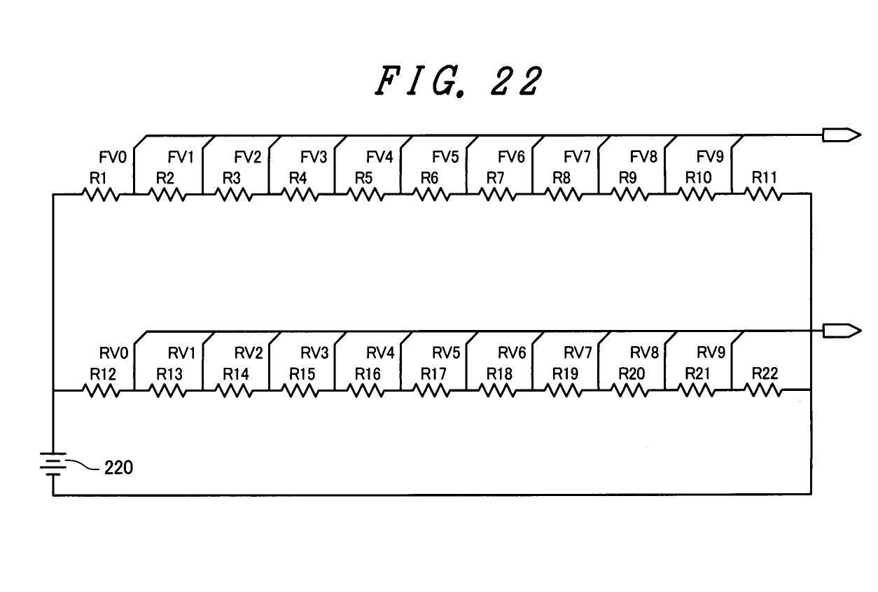

Next, the specific circuit constitution of the gray scale setting circuits 154, 155 is explained in conjunction with FIG. 22. FIG. 22 shows the specific constitution when the separate gray scale reference voltages are generated for the front face liquid crystal panel 152 and the rear face liquid crystal panel 153.

As shown in FIG. 22, the gray scale setting circuit is configured as follows. A resistor R1, a resistor R2, . . . , a resistor R10, a resistor R11 are connected to a power source 220 in series thus generating voltages FV0, FV1, . . . , FV8, FV9 by the resistance division, whereby the gray scale reference voltages are outputted to the source driver 1521 of the front face liquid crystal panel 152. Further, separately from the above constitution, a resistor R12, a resistor R13, . . . , a resistor R21, a resistor R22 are connected to the power source 220 in series thus generating voltages RV0, RV1, . . . , RV8, RV9 by the resistance division, whereby the gray scale reference voltages are outputted to the source driver 1531 of the rear face liquid crystal panel 153.

In such a constitution, by providing two systems which output the voltages to the front face liquid crystal panel 152 and the rear face liquid crystal panel 153 and by separately setting the resistance value of the respective systems, it is possible to generate independent gray scale reference voltages.

Here, in FIG. 22, an upper portion indicates the gray scale setting circuit 154 shown in FIG. 21 and a lower portion indicates the gray scale setting circuit 155 shown in FIG. 21. In this embodiment 7, by providing two systems in the gray scale setting circuit for the front face liquid crystal panel 152 and the rear face liquid crystal panel 153, in response to the gray scale signals given in common to the front face liquid crystal panel 152 and the rear face liquid crystal panel 153 from the timing controller (TCON) 46, it is possible to supply the separate gray scale reference voltages 343, 344 to the respective source drivers. In the source driver 1521 of the front face liquid crystal panel 152, a predetermined voltage is transmitted to the front face liquid crystal panel 152 in response to the gray scale reference voltage 343 and the RGB signal 55 (see FIG. 4) for the front face liquid crystal panel of the output I/F signal 341.

Further, in the source driver 1531 of the rear face liquid crystal panel 153, a predetermined voltage is transmitted to the rear face liquid crystal panel 152 in response to the gray scale reference voltage 344 and the RGB signal 56 (see FIG. 4) for the rear face liquid crystal panel of the output I/F signal 341.

In this embodiment, due to such a constitution, even when one kind of luminance distribution table is used, it is possible to supply desired gray scale reference voltages to the front face liquid crystal panel and the rear face liquid crystal panel.

[Embodiment 8]

In the embodiment 8, the temperature change is detected using temperature sensors and a γ setting circuit which changes liquid crystal voltages corresponding to gray scales is provided.

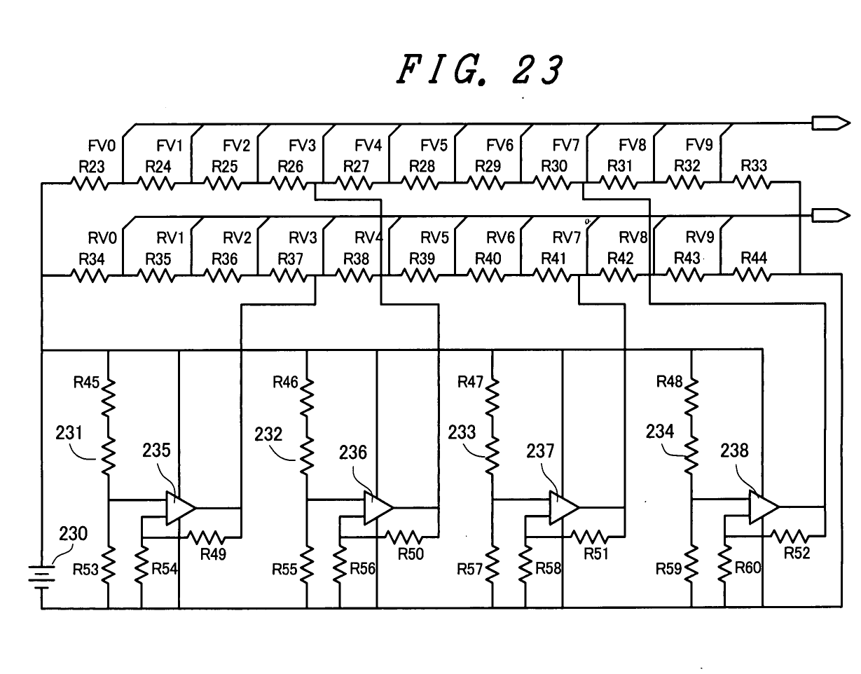

FIG. 23 shows a circuit which provides a temperature detecting circuit in the inside of a gray scale setting circuit arranged on the TCON board 34 and generates gray scale reference voltages corresponding to the temperature change.

In FIG. 23, numerals 231, 232, 233, 234 indicate thermistors (temperature sensors) which detect the temperature, and numerals 235, 236, 237 and 238 indicate operational amplifiers. The thermistor 231 and the operational amplifier 235 are combined with each other, and an output from the operational amplifier 235 is connected between a resistor R37 and a resistor R38. Further, the thermistor 232 and the operational amplifier 236 are combined with each other, and an output from the operational amplifier 236 is connected between a resistor R26 and a resistor R27. Further, the thermistor 233 and the operational amplifier 237 are combined with each other, and an output from the operational amplifier 237 is connected between a resistor R41 and a resistor R42. Still further, the thermistor 234 and the operational amplifier 238 are combined with each other, and an output from the operational amplifier 238 is connected to a resistor R30 and a resistor R31.

Here, in the above-described constitution, a series of resistors (R23, R24, . . . , R32, R33) on an upper side provides the constitution for generating the gray scale reference voltages for the upper-side liquid crystal panel in the same manner as the resistors (R1, R2, . . . , R10, R11) on the upper side in FIG. 22, while a series of resistors (R34, R35, . . . , R43, R44) on a lower side provides the constitution for generating the gray scale reference voltages for the lower-side liquid crystal panel in the same manner as the resistors (R12, R13, . . . , R21, R22) on the lower side in FIG. 22. The thermistors are preliminarily mounted at positions where the correlation between the liquid crystal panel and the temperature is established and possess suitable values and characteristics.

By applying the voltage correction to two points of the respective division voltages obtained by dividing the power source 230 based on the ladder resistance consisting of R23, R24, . . . , R32, R33, using the thermistors and operational amplifiers, the gray scale voltages for the upper-side liquid crystal panel are changed thus enabling the change of the y curves (luminance vs voltage curve). In the same manner, by applying the voltage correction to two points of the respective division voltages obtained by dividing the power source 230 based on the ladder resistance consisting of R34, R35, . . . , R43, R44, using the thermistors and operational amplifiers, the gray scale voltages for the lower-side liquid crystal panel are changed thus enabling the change of the γ curves (luminance vs. voltage curve).

What is claimed is:

1. A display device for generating a three-dimensional image by overlapping a two-dimensional image which is displayed on a display part of a first display device and a two-dimensional image which is displayed on a display part of a second display device, the display device comprising:
a first display signal generating device which outputs a display timing signal and display data for said first display device to said first display device as a first output I/F signal based on a first input I/F signal which is inputted from the outside; and
a second display signal generating device which outputs a display timing signal and display data for said second display device to said second display device as a second output I/F signal based on a second input I/F signal which is inputted from the outside.

2. A display device according to claim 1, wherein said first display device is constituted of a front liquid crystal panel and said second display device is constituted of a rear liquid crystal panel which is overlapped to a rear of said front liquid crystal panel, and
said first display signal generating device is constituted of a first timing controller for said front liquid crystal panel, and said second display signal generating device is constituted of a second timing controller for said rear liquid crystal panel.

3. A display device which is constituted by overlapping a front liquid crystal panel and a rear liquid crystal panel, said display device comprising:
a timing controller board on which a timing controller which is connected to said front liquid crystal panel and said rear liquid crystal panel is arranged, wherein
said timing controller outputs an output I/F signal to said front liquid crystal panel and said rear face liquid crystal panel based on an input I/F signal inputted from an external image signal source.

4. A display device according to claim 3, wherein said input I/F signal is used as the signal which is used in common by said front liquid crystal panel and said face liquid crystal panel, and said output I/F signal is separately outputted as the output signal for said front liquid crystal panel and the output signal for said rear liquid crystal panel.

5. A display device according to claim 4, wherein the sum of number of input-side terminals on said timing controller is smaller than the sum of number of output-side terminals.

6. A display device according to claim 3, wherein said input I/F signal includes RGB signals which indicate color information and hierarchical information which indicates a position between said front liquid crystal panel and said rear liquid crystal panel.

7. A display device according to claim 6, wherein the sum of the number of terminals relevant to the color information and the hierarchical information on said input side of said timing controller is set smaller than the sum of the number of terminals relevant to the color information on the output side.

8. A display device according to claim 6, wherein said timing controller mounted on said timing controller board includes an integral memory, and
said integral memory is constituted of six memories for RGB of said front liquid crystal panel and RGB of said rear liquid crystal panel, and the memories store luminance distribution tables which are color information for generating output I/F signals for said front liquid crystal panel and said rear liquid crystal panel in response to said input I/F signal.

9. A display device according to claim 8, wherein said timing controller mounted on said timing controller board includes an integral memory and an external memory,
said external memory stores luminance distribution tables for generating output I/F signals for said front liquid crystal panel and said rear liquid crystal panel which are generated in response to display characteristics of said front face liquid crystal panel and said rear face liquid crystal panel in response to said input I/F signals, and
said integral memory includes a memory capacitance necessary for storing said luminance distribution tables which are transferred from said external memory.

10. A display device according to claim 9, wherein said external memory enables the rewriting of said luminance distribution tables from the outside to cope with the display characteristics of said front liquid crystal panel and said rear liquid crystal panel.

11. A display device according to claim 7, wherein when said input I/F signal is configured such that each of the color information RGB includes 6-bits information and the hierarchical information includes 6-bits information, the number of input-side terminals is 24 and the number of output-side terminals is 36.

12. A display device according to claim 3, wherein a backlight device is mounted on a back surface of said rear liquid crystal panel.

13. A display device according to claim 3, wherein said timing controller board includes a gray scale setting circuit which generates gray scale reference voltages which are common between said front liquid crystal panel and said rear liquid crystal panel.

14. A display device according to claim 13, wherein said timing controller which is mounted on said timing controller board includes an integral memory, and
said internal memory includes a luminance distribution table which stores information for generating output I/F signals for said front liquid crystal panel and said rear liquid crystal panel in response to said input I/F signals.

15. A display device according to claim 14, wherein said output I/F signals are outputted in response to the temperatures of said front liquid crystal panel and said rear liquid crystal panel.

16. A display device according to claim 3, wherein said timing controller board includes a gray scale setting circuit for said front liquid crystal panel which generates gray scale reference voltages of said front liquid crystal panel and a gray scale setting circuit for said rear liquid crystal panel which generates gray scale reference voltages of said rear liquid crystal panel.

17. A display device according to claim 15, wherein said timing controller which is mounted on said timing controller board includes an integral memory, and
said integral memory includes a common luminance distribution table which stores information for generating output I/F signals for said front liquid crystal panel and said rear liquid crystal panel in response to said input I/F signals.

18. A display device according to claim 3, wherein said timing controller board includes a gray scale generating circuit which generates gray scale reference voltages which are supplied to said front liquid crystal panel and said rear face liquid crystal panel.

19. A display device according to claim 18, wherein said gray scale generating circuit is constituted of a two-system generating circuits for said front liquid crystal panel and said rear liquid crystal panel.

20. A display device according to claim 18, wherein said gray scale generating circuit is constituted of a one-system generating circuits which is used in common by said front liquid crystal panel and said rear liquid crystal panel.
